(19) United States
(12) Patent Application Publication
(10) Pub. No.: US 2006/0262359 A1
(43) Pub. Date: Nov. 23, 2006

(54) Image scanning device having network scan function and network scanning method and system using the image scanning device

(75) Inventor: Dong-hoon Lee, Metropolitan-city (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/434,114

(22) Filed: May 16, 2006

(30) Foreign Application Priority Data
May 19, 2005 (KR) 2005-42183

(51) Int. Cl. H04N 1/04

(52) U.S. Cl. 358/474; 358/1.15

(57) ABSTRACT

A network scanning apparatus, method and system enable scan data generated by a scanner or a multifunctional device having a scan function to be transmitted to any of a plurality of PCs connected to a network at a user's request. The network scanning system includes: an image scanning device which receives a scan request signal from a second terminal connected thereto via a local connection, generates scan data by scanning a document, and transmits the generated scan data to the second terminal; and the second terminal which transmits the scan data transmitted by the image scanning device to the first terminal connected thereto via a network. Accordingly, a typical image scanning device, such as a scanner, transmits scan data to a PC equipped with a network card via a local connection set up therebetween, and then the PC transmits the scan data to any of a plurality of PCs connected thereto via a network. Therefore, the image scanning device can use such a convenient network scan function without a requirement of a network card.

### CROSS-REFERENCE TO RELATED APPLICATIONS

This application claims the benefit of Korean Application No. 2005-42183, filed on May 19, 2005, in the Korean Intellectual Property Office, the disclosure of which is incorporated herein by reference.

### BACKGROUND OF THE INVENTION

1. Field of the Invention

Aspects of the present invention relate to a network scan function of a scanner or a multifunction device by which scan data generated by scanning a document is transmitted to a desired terminal in a network where a plurality of terminals, such as personal computers, are located, and more particularly, to a network scanning method, apparatus, and system which enable an image scanning device (e.g., a scanner) not equipped with a network card to use the network scan function.

2. Description of the Related Art

In general, multifunctional devices having a scan function read document data from pages of a document and then print the read document data or transmit the read document data using a communication device such as a modem. A network scan function is a function by which a plurality of terminals, e.g., PCs, are allowed to share a scanner or a multifunctional device having a scan function, and by which scan data generated by the shared scanner or the multifunctional device can be transmitted to any of the terminals.

FIG. 1 is a block diagram of a conventional network scanning system using a scanner 100 having a typical network scan function. Referring to FIG. 1, the network scanning system includes the scanner 100, which is equipped with a network card 110, an Ethernet network 120, and a plurality of PCs, i.e., first, second, and third PCs 130, 140, and 150, which are connected to the scanner 100 via the Ethernet network 120.

A user executes a network scanning program in one of the first, second, and third PCs 130, 140, and 150, such as, for example, the first PC 130. The scanner 100 receives a scan request signal from the user via the Ethernet 120 and also receives an IP address and authentication information (such as an ID and a password) of the PC to which scan data and scan options are requested to be transmitted. Thereafter, the scanner 100 generates scan data by scanning a predetermined document according to the received options and transmits the scan data to the PC corresponding to the received IP address via the Ethernet 120.

As described above, in order to use a conventional network scanning system, an image scanning device such as, for example, a scanner, must have a network card, and if it does not have one, an additional cost of purchasing a network card is incurred.

### SUMMARY OF THE INVENTION

Aspects of the present invention provide a network scanning method, apparatus, and system which allow a network scan function to be performed by an image scanning device, such as a scanner or a multifunctional device having a scan function, which is not equipped with a network card, thereby avoiding the additional cost of purchasing a network card.

Additional aspects and/or advantages of the invention will be set forth in part in the description which follows and, in part, will be obvious from the description, or may be learned by practice of the invention.

According to an aspect of the present invention, there is provided a network scanning method in which an image scanning device having a scan function generates scan data by scanning a document for transmission of the scan data to a first terminal via a network. The network scanning method includes: receiving a scan request that designates the first terminal as a destination; generating scan data by scanning a document in response to the scan request; and transmitting the scan data to a second terminal connected to the image scanning device via a local connection. The first and second terminals are connected to each other via a network, and the second terminal transmits the scan data generated by a scanning unit to the first terminal via the network.

The network scanning method may also include receiving an address or a name of the first terminal.

The network scanning method may also include receiving at least one of authentication information regarding the first terminal and scan options, the authentication information comprising an ID and a password necessary to access the first terminal.

According to another aspect of the present invention, there is provided a method of transmitting scan data generated by an image scanning device to at least one terminal. The method includes: receiving a scan request signal via a network connection and transmitting the received scan request signal to the image scanning device via a local connection; receiving scan data generated by scanning a document, in response to the scan request signal, from the image scanning device via the local connection; and transmitting the scan data to at least one terminal via the network connection.

The method may also include receiving an address or a name of the terminal from the image scanning device via the local connection.

The method may also include generating information regarding a plurality of terminals connected to one another via the network.

The method may be implemented by one of a network scan driver or a network scanning application program.

According to another aspect of the present invention, there is provided an image scanning device having a network scan function, which generates scan data by scanning a document for transmission of the scan data to a first terminal. The image scanning device includes: a scanning unit which generates the scan data by scanning a document in response to a scan signal; and a data transmission and reception unit which receives the scan request signal from a second terminal, which is connected to the image scanning device via a local connection, and transmits the scan data generated by the scanning unit to the second terminal. The first and second terminals are connected to each other via a network, and the second terminal transmits the scan data generated by the scanning unit to the first terminal via the network.

The image scanning device may also include a user input unit which receives one of an address and a name of the first terminal.

The user input unit may receive at least one of authentication information regarding the first terminal or scan options, and the authentication information may include an ID and a password necessary to access the first terminal.

The data transmission and reception unit may transmit the address of the first terminal to the second terminal via the local connection.

According to another aspect of the present invention, there is provided a network scanning system which transmits scan data generated by an image scanning device to a first terminal connected to a network. The network scanning system includes: an image scanning device which receives a scan request signal from a second terminal connected thereto via a local connection, generates scan data by scanning a document in response to the scan request signal, and transmits the generated scan data to the second terminal; and the second terminal which transmits the scan data transmitted by the image scanning device to the first terminal connected thereto via a network.

The image scanning device may receive one of an address or a name of the first terminal from a user.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional network scanning system using a scanner having a typical network scan function;

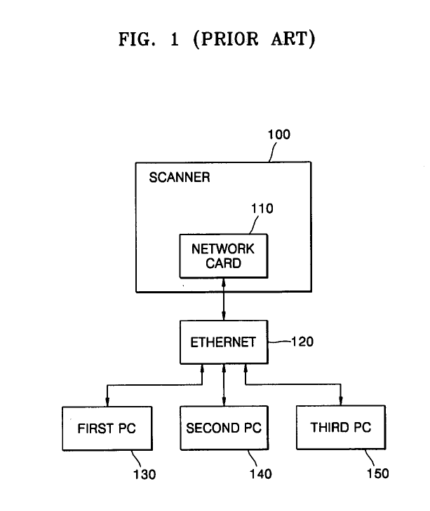

FIG. 2 is a block diagram of a network scanning system according to an exemplary embodiment of the present invention;

FIG. 3 is a detailed block diagram of a scanner and a server PC of FIG. 2; and

FIG. 4 is a flowchart illustrating a network scanning method according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

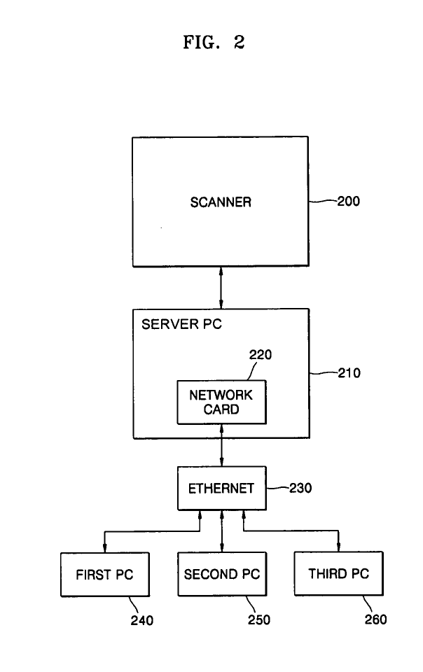

FIG. 2 is a block diagram of a network scanning system according to an embodiment of the present invention. Referring to FIG. 2, the network scanning system includes a scanner 200, a server PC 210 equipped with a network card 220, an Ethernet network 230, and a plurality of PCs, i.e., first, second, and third PCs 240, 250, and 260. The scanner 200 and the server PC 210 are connected to each other via a local connection, such as a universal serial bus (USB) or a parallel bus, so that they can transmit data to each other. The first, second, and third PCs 240, 250, and 260 are connected to the server PC 210 via the Ethernet network 230 with the aid of their respective network cards so that they can transmit data to or receive data from the server PC 210. Even though only three PCs are illustrated in FIG. 2 as being connected to the server PC 210, more than or less than three PCs can be connected to the server PC 210.

A user selects the IP address of the first, second, or third PCs 240, 250, or 260 that he or she wishes scan data to be transmitted to and sets scan options using a user interface (not shown) of the scanner 200. The user may elect to send the scan data to more than one PC. The scanner 200 generates scan data by scanning a desired document according to the scan options set by the user and transmits the scan data and the IP address selected by the user to the server PC 210 via the local connection to the server PC 210.

The user may select the name of the first, second, or third PCs 240, 250, or 260 instead of directly inputting the IP address of the PC that he or she wishes the scan data generated by the scanner 200 to be transmitted to. Alternatively, one of the first, second, or third PCs 240, 250, or 260 may transmit a scan request signal to the scanner 200 together with its IP address and the IP address of any other PCs to which the user may wish to send the scan data.

For the security of the first, second, and third PCs 240, 250, and 260, the user may be requested to input to the network scanning system authentication information, such as an ID and a password set for the PC that the user wishes the scan data to be transmitted to and to be authenticated, thereby determining whether the user is authorized to access the PC that he or she wishes the scan data to be transmitted to.

The server PC 210 transmits the scan data transmitted by the scanner 200 to the PC with the selected IP address via a network connection set up therebetween using the network card 220 and the Ethernet 230.

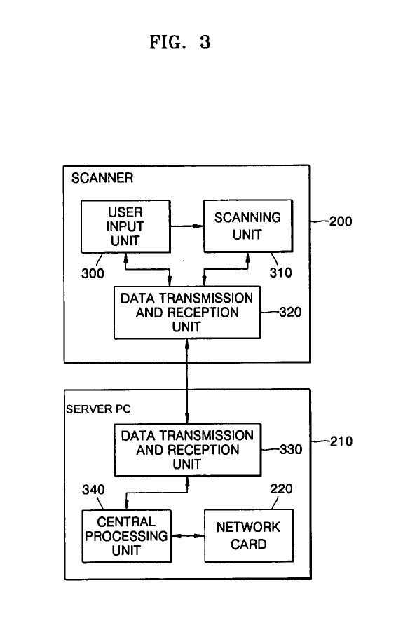

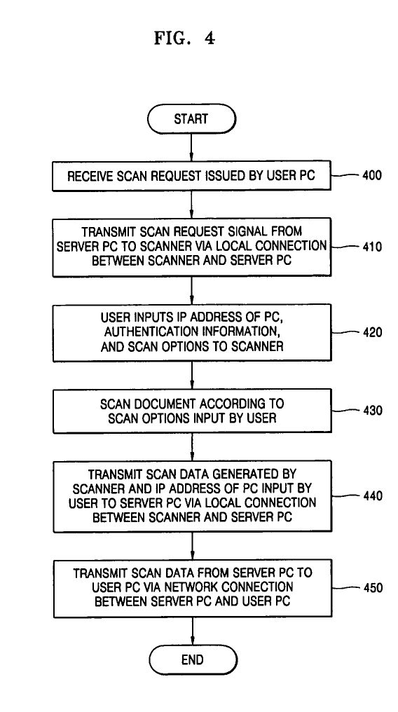

FIG. 3 is a detailed block diagram of the scanner 200 and the server PC 210 of FIG. 2. Referring to FIG. 3, the scanner 200 includes a user input unit 300, a scanning unit 310, and a data transmission and reception unit 320, and the server PC 210 includes a data transmission and reception unit 330, a central processing unit 340, and the network card 220. The operations of the scanner 200 and the server PC 210 will now be described with reference to FIG. 4, which is a flowchart illustrating a network scanning method according to an exemplary embodiment of the present invention.

Referring to FIGS. 2 through 4, in operation 400, a user issues a network scan request by executing a network scanning application installed in one of the first, second, or third PCs 240, 250, or 260 (hereinafter referred to as the user PC), and the user PC prepares itself to transmit or receive data via the Ethernet 230 by opening up a network port for data transmission. Alternatively, the scan request can come from any other source, such as, for example, a user-activated interface on the scanner itself or another user PC.

In operation 410, the network card 220 included in the server PC 210 receives the network scan request issued by the user from the user PC via the Ethernet 230, and the central processing unit 340 generates a network scan request signal and transmits the network scan request signal to the scanner 200 by using a local connection between the data transmission and reception unit 330 of the server PC 210 and the data transmission and reception unit 320 of the scanner 200.

When the data transmission and reception unit 320 of the scanner 200 receives the network scan request signal from the server PC 210 or from another source, the scanner 200 enters a network scan settings input mode. In operation 420, in the network scan settings input mode, the user input unit 300 receives various setting values related to network scanning, such as an IP address of one of the PCs 240, 250, and 260 that the user wishes scan data generated by the scanner 200 to be transmitted to, authentication information, e.g., an ID and a password necessary to access the PC that the user wishes scan data generated by the scanner 200 to be transmitted to, and scan options used to scan a document. The authentication information is used to determine whether the user is authorized to access the PC that he or she wishes scan data generated by the scanner 200 to be transmitted to. If the user inputs an incorrect ID or password to the network scanning system in operation 420, a warning message may be displayed to the user, and no subsequent operations are carried out.

In the network scan settings input mode, a display unit (not shown) included in the scanner 200 may display a plurality of settings related to network scanning which can be set by the user.

In operation 430, the scanning unit 310 scans a desired document in response to the scan request, thereby generating scan data. If the user has input scan options to the network scanning system in operation 420, the scanning unit 310 may scan the desired document according to the scan options input by the user. Otherwise, the scanning unit 310 may scan the desired document according to predetermined basic scan options.

In operation 440, the data transmission and reception unit 320 of the scanner 200 receives IP address information specifying the IP address or addresses input by the user from the user input unit 300 and transmits the received IP address information to the server PC 210. In addition, in operation 440, the data transmission and reception unit 320 of the scanner 200 receives the scan data generated by the scanning unit 310 and transmits the received scan data to the server PC 210. Then, the data transmission and reception unit 330 of the server PC 210 receives the IP address information and the scan data transmitted by the data transmission reception unit 320 of the scanner 200. As described above, the data transmission and reception unit 320 of the scanner 200 and the data transmission and reception unit 330 of the server PC 210 are connected to each other via a local connection using a USB or a parallel bus.

The central processing unit 340 determines which of the first, second, and third PCs 240, 250, and 260 the scan data received from the scanner 200 is to be transmitted to by analysing the IP address information received from the scanner 200 and packetizes the received scan data so that the received scan data becomes transmittable via a network. In operation 450, the network card 220 transmits the packetized scan data via the Ethernet 230 to the PC or PCs determined as the destination of the received scan data.

It is to be understood that although the aspects of the present invention have been described with reference to a particular embodiment comprising a scanner, a server PC equipped with a network card, an Ethernet network, and a plurality of PCs, the invention is not limited to methods and devices comprising these components. More broadly, a network scanning method in which an image scanning device having a scan function generates scan data by scanning a document for transmission of the scan data to a first terminal via a network may include receiving a scan request, which may issued by the first terminal or another source; generating scan data by scanning a document in response to the scan request; and transmitting the scan data to a second terminal connected to the image scanning device via a local connection, wherein the first and second terminals are connected to each other via a network, and the second terminal transmits the scan data to the first terminal via the network. The method is not limited to the transmission of scan data to a single terminal, and the scan request may designate additional terminals to which the scan data is to be sent. The image scanning device can include a scanning unit that generates scan data by scanning a document in response to a scan request; and a data transmission and reception unit that can receive a scan request signal from a second terminal, which is connected to the image scanning device via a local connection, and transmits the scan data generated by the scanning unit to the second terminal. As discussed above, the first and second terminals, and any additional terminals to which the data is to be sent, are connected to each other via a network, and the second terminal transmits the scan data generated by the scanning unit to the first terminal and to any additional terminals via the network. A network scanning system that transmits scan data generated by an image scanning device to a first terminal connected to a network includes an image scanning device, which can receive a scan request signal from a second terminal connected thereto via a local connection, generates scan data by scanning a document in response to the scan request, and transmits the generated scan data to the second terminal. The network scanning system includes the second terminal, which transmits the scan data transmitted by the image scanning device to the first terminal connected thereto via a network.

Accordingly, the first terminal may be a user PC, or may be any computing device that is capable of issuing a scan request and receiving scan data via a network. Typically, a network will include a plurality of terminals, and, in such a case, the terminal that is designated herein as the “first terminal” is a terminal selected by a user to issue a scan request and/or to receive scan data. The second terminal may be a server PC, or may be any computing device that is capable of receiving a scan request via a network connection, transmitting the request to an image scanning device by way of a local connection, receiving scan data from an image scanning device and transmitting scan data to another terminal via a network connection. The network that connects the first terminal and the second terminal may be an Ethernet network, or can be any shared network, such as, for example, any shared network requiring a network card.

The network scanning method according to an embodiment of the present invention may be implemented by a network scan driver or a network scanning application program.

Aspects of the present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage medium, and a carrier wave (e.g., data transmission through the Internet).

As described above, according to an aspect of the present invention, an image scanning device, such as a scanner, transmits scan data to a PC equipped with a network card via a local connection set up therebetween, and then the PC transmits the scan data to any of a plurality of PCs connected thereto via a network. Therefore, even a typical image scanning device can use such a convenient network scan function without the aid of a network card.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A network scanning method in which an image scanning device having a scan function generates scan data by scanning a document for transmission of the scan data to a first terminal via a network, the network scanning method comprising:
receiving a scan request that designates the first terminal as a destination;
generating scan data by scanning a document in response to the scan request; and
transmitting the scan data to a second terminal connected to the image scanning device via a local connection,
wherein the first and second terminals are connected to each other via a network, and the second terminal transmits the scan data to the first terminal via the network.

2. The network scanning method of claim 1, further comprising receiving an address or a name of the first terminal for transmission of the scan data to the first terminal.

3. The network scanning method of claim 1, further comprising receiving at least one of authentication information regarding the first terminal or scan options, the authentication information comprising an ID and a password necessary to access the first terminal.

4. The network scanning method of claim 1, wherein local connection between the second terminal and the image scanning device is via a universal serial bus or a parallel bus.

5. The network scanning method of claim 1, wherein the image scanning device does not have a network card.

6. The network scanning method of claim 1, wherein the scan request is transmitted from the first terminal to the second terminal via the network and is received by the image scanning device from the second terminal via the local connection.

7. The network scanning method of claim 1, wherein the scan request designates at least one additional terminal as a destination and wherein the at least one additional terminal is connected to the first and second terminals via the network and wherein the second terminal transmits the scan data to said at least one additional terminal via the network.

8. A method of transmitting scan data generated by an image scanning device to at least one terminal, comprising:
receiving a scan request signal via a network connection, wherein the scan request signal designates at least one terminal as a destination, and transmitting the received scan request signal to the image scanning device via a local connection;
receiving scan data generated by scanning a document in response to the scan request signal, wherein the scan data is received from the image scanning device via the local connection; and
transmitting the scan data to the at least one terminal via the network connection.

9. The method of claim 8, further comprising receiving an address or a name of the at least one terminal from the image scanning device via the local connection for transmission of the scan data to the at least one terminal.

10. The method of claim 8, further comprising generating information regarding a plurality of terminals connected to one another via the network.

11. The method of claim 8, wherein the method is implemented by a network scan driver or a network scanning application program.

12. The method of claim 8, wherein the local connection is via a universal serial bus or a parallel bus.

13. The method of claim 8, wherein the image scanning device does not have a network card.

14. A computer-readable recording medium storing a computer program for executing the network scanning method of claim 1.

15. A computer-readable recording medium storing a computer program for executing the method of claim 8.

16. An image scanning device having a network scan function, which generates scan data by scanning a document for transmission of the scan data to a first terminal, the image scanning device comprising:
a scanning unit which generates the scan data by scanning the document in response to a scan request signal;
a user input unit which receives an address or a name of the first terminal for transmission of the scan data to the first terminal; and
a data transmission and reception unit which receives the scan request signal from a second terminal, which is connected to the image scanning device via a local connection, and transmits the scan data to the second terminal,
wherein the first and second terminals are connected to each other via a network, and the second terminal transmits the scan data to the first terminal via the network.

17. The image scanning device of claim 16, wherein the user input unit receives at least one of authentication information regarding the first terminal or scan options, and the authentication information comprises an ID and a password necessary to access the first terminal.

18. The image scanning device of claim 16, wherein the data transmission and reception unit transmits the address of the first terminal to the second terminal via the local connection.

19. The image scanning device of claim 16, wherein the local connection is via a universal serial bus or a parallel bus.

20. The image scanning device of claim 16, wherein the image scanning device does not have a network card.
